(19) United States
(12) Patent Application Publication
(10) Pub. No.: US 2026/0127546 A1
(43) Pub. Date: May 7, 2026

(54) METHODS AND SYSTEMS FOR INTELLIGENTLY AND ADAPTIVELY MANAGING AND USING DATA IN A SUPPLY CHAIN ENVIRONMENT

(71) Applicant: GrubMarket, Inc., South San Francisco, CA (US)

(72) Inventors: Shangyan LI, South San Francisco, CA (US); David Qiuye YANG, South San Francisco, CA (US)

(73) Assignee: GrubMarket, Inc., South San Francisco, CA (US)

(21) Appl. No.: 19/382,011

(22) Filed: Nov. 6, 2025

Related U.S. Application Data
(60) Provisional application No. 63/717,508, filed on Nov. 7, 2024.

(51) Int. Cl. G06Q 10/087; G06F 3/0486; G06N 20/00; G10L 15/26

(52) U.S. Cl. CPC G06Q 10/0874; G06F 3/0486; G06N 20/00; G10L 15/26

(57) ABSTRACT

Disclosed herein are systems and methods for the automated ingestion and processing of orders for the food supply chain industry using artificial intelligence. An example method can comprise extracting order level information and item level information from a purchase order in the form of at least one of an email message, a text message, a voicemail audio file, an image file, a spreadsheet file, and a portable document format (PDF) file. The method can also comprise preprocessing the order level information and the item level information into a plurality of machine learning features and inputting the machine learning features into a machine learning model to obtain predictions concerning the purchase order. A sales order can then be generated based in part on the predictions outputted by the machine learning model.

### CROSS-REFERENCE TO RELATED APPLICATION

This application claims the benefit of U.S. Provisional Application No. 63/717,508, filed Nov. 7, 2024, which is incorporated herein by reference in its entirety.

### TECHNICAL FIELD

This disclosure relates generally to the field of supply chain management software and more specifically, to systems and methods for the automated ingestion and processing of orders using artificial intelligence.

### BACKGROUND

Many purchasers or buyers (e.g., grocery store purchasers, retail store purchasers, restaurant buyers, etc.) in the food supply chain industry still prefer to place their orders for suppliers or distributors over email, voicemail, or text messaging. This is due to the fact that such purchasers often order anywhere between 10+ to 100+ items and often accompany these orders with customized instructions for the items in these orders. Purchasers often do not have the time to browse and search through a wholesale food distributor's vast product catalog. These purchasers would prefer to let the distributor know what items they need and let the distributor figure out how best to match the purchaser's order with the actual products in the distributor's product catalog.

This creates the all-too-common scenario where the distributor or supplier must expend a significant amount of time to carefully match the purchaser's requested items, often sent via email, voicemail, and/or text messages, with the products in the supplier's or distributor's product catalog and manually key in every item being ordered. Manual ordering not only slows down operations but is also prone to human error, which can result in costly delays and a poor customer experience.

Therefore, a solution is needed that leverages the power of AI to automate the ingestion and processing of orders. Such a solution should be user-friendly and cost-effective to deploy and manage.

### SUMMARY

Disclosed are systems and methods for the automated ingestion and processing of orders in a supply chain environment (e.g., a food supply chain environment) using artificial intelligence (AI). As will be discussed in more detail in the following sections, the systems and methods disclosed herein can leverage AI to ingest inbound purchase orders from numerous purchasers or customers in various formats and automatically generate sales orders based on such inbound purchase orders for numerous suppliers accurately and efficiently. The system can also push the sales orders directly into a supplier's enterprise resource planning (ERP) system automatically. This saves significant resources for the suppliers in terms of time and labor costs The AI models used by the system can self-learn and improve its performance over time as more orders are processed.

In some embodiments, a method of automatically ingesting and processing an order comprises extracting, using a large language model (LLM), order level information and item level information from a purchase order. The purchase order can be in the form of an email message, a text message, a voicemail audio file, an image file (e.g., a digital photo of an order), a spreadsheet file, a portable document format (PDF) file, or a combination thereof.

The order level information comprises at least a customer name, a delivery date, and a customer purchase order (PO) number. The item level information comprises one or more generic product names.

The method further comprises preprocessing the order level information and the item level information into a plurality of machine learning features. The method also comprises inputting the machine learning features into a machine learning model to obtain predictions concerning a product code from a product database corresponding to one of the generic product names, the delivery date, the customer purchase order number, and a customer record corresponding to the customer name.

The method further comprises automatically generating a sales order from the inbound purchase order based in part on the product code, the delivery date, the customer purchase order number, and the customer record predicted by the machine learning model and displaying the sales order to a supplier via a supplier client device.

In some embodiments, the method further comprises displaying, via the supplier client device, the sales order to the supplier via an editable graphical user interface (GUI) and receiving one or more corrections to the sales order from the supplier via user inputs applied to the editable GUI resulting in a corrected sales order. The method also comprises comparing the one or more corrections to the predictions outputted by the machine learning model and adjusting or fine-tuning a plurality of weights of the machine learning model until new predictions outputted by the machine learning model using the same inputs match or more closely align with the corrected sales order.

In some embodiments, preprocessing the item level information further comprises preprocessing the one or more generic product names into the plurality of machine learning features. In certain embodiments, the machine learning features can comprise one or more fuzzy text match scores and one or more semantic embedding similarity scores.

In some embodiments, the method further comprises inputting a plurality of auxiliary features into the machine learning model to obtain the predictions concerning the product code. The auxiliary features are not explicitly included as part of the purchase order. The auxiliary features can comprise data or information concerning a day that the purchase order was received, a month that the purchase order was received, a current season during which the purchase order was received, and a current weather condition during which the purchase order was received.

In some embodiments, the method further comprises inputting a plurality of customer-specific features into the machine learning model to obtain the predictions concerning the product code. The plurality of customer-specific features are not explicitly included as part of the purchase order. The plurality of customer-specific features can comprise an order history associated with a customer, an order frequency associated with the customer, and an order guide or product list made available to the customer.

In some embodiments, the machine learning model can be another instance of the LLM or an additional LLM.

In some embodiments, the purchase order can be divided into a first partial order and a second partial order. The first partial order can be in the form of the email message, the text message, the voicemail audio file, the image file, the spreadsheet file, or the PDF file. The second partial order can be in a different form from the first partial order.

In some embodiments, the purchase order can be in the form of the voicemail audio file. In these embodiments, the method further comprises transcribing the voicemail audio file into transcribed text using an additional LLM and extracting the order level information and the item level information from the transcribed text.

In some embodiments, extracting the order level information using the LLM further comprises extracting, optionally, a shipping address from the purchase order. In these and other embodiments, extracting the item level information using the LLM further comprises extracting units of measure, quantities, and prices from the purchase order.

In some embodiments, the method further comprises displaying an order GUI on the supplier client device and receiving the purchase order in response to a supplier dragging and dropping the voicemail audio file or the PDF file onto the order GUI.

In some embodiments, the method further comprises automatically adding the sales order to an enterprise resource planning (EPR) database of a distributor or supplier.

Also disclosed is a system for processing orders in an automated manner. The system comprises a server and a supplier client device communicatively coupled to the server.

The server comprises one or more processors and one or more memory units communicatively coupled to the one or more processors. The one or more memory units store instructions that, when executed by the one or more processors, cause the one or more processors to extract, using an LLM, order level information and item level information from a purchase order.

The purchase order can be in the form of at least one of an email message, a text message, a voicemail audio file, an image file, a spreadsheet file, and a portable document format (PDF) file. The order level information comprises at least a customer name, a delivery date, and customer purchase order number and the item level information comprises one or more generic product names.

The one or more memory units can store further instructions that, when executed by the one or more processors, cause the one or more processors to preprocess the order level information and the item level information into a plurality of machine learning features, input the machine learning features into a machine learning model to obtain predictions concerning a product code from a product database corresponding to one of the generic product names, the delivery date, the customer purchase order number, and a customer record corresponding to the customer name, and generate a sales order based in part on the product code, the delivery date, the customer purchase order number, and the customer record predicted by the machine learning model. The supplier client device can be configured to display the sales order to a supplier.

In some embodiments, the one or more memory units store further instructions that, when executed by the one or more processors, cause the one or more processors to: instruct the supplier client device to display the sales order to the supplier via an editable GUI, receive one or more corrections to the sales order from the supplier via user inputs applied to the editable GUI resulting in a corrected sales order, compare the one or more corrections to the predictions outputted by the machine learning model, and adjust or fine-tune a plurality of weights of the machine learning model until new predictions outputted by the machine learning model using the same inputs match or more closely align with the corrected sales order.

In some embodiments, the one or more memory units store further instructions that, when executed by the one or more processors, cause the one or more processors to preprocess the item level information by further preprocessing the one or more generic product names into the plurality of machine learning features. The machine learning features comprise one or more fuzzy text match scores and one or more semantic embedding similarity scores.

In some embodiments, the one or more memory units store further instructions that, when executed by the one or more processors, further cause the one or more processors to input a plurality of auxiliary features into the machine learning model to obtain the predictions concerning the product code. In these embodiments, the auxiliary features are not explicitly included as part of the purchase order. The auxiliary features comprise data or information concerning a day that the purchase order was received, a month that the purchase order was received, a current season during which the purchase order was received, and a current weather condition during which the purchase order was received.

In some embodiments, the one or more memory units store further instructions that, when executed by the one or more processors, further cause the one or more processors to input a plurality of customer-specific features into the machine learning model to obtain the predictions concerning the product code. In these embodiments, the plurality of customer-specific features are not explicitly included as part of the purchase order. The plurality of customer-specific features comprise an order history associated with a customer, an order frequency associated with the customer, and an order guide or product list made available to the customer.

Also disclosed are one or more non-transitory computer-readable media comprising instructions stored thereon, that when executed by one or more processors, cause the one or more processors to perform certain operations. The operations comprise extracting, using an LLM, order level information and item level information from a purchase order. The purchase order can be in the form of at least one of an email message, a text message, a voicemail audio file, an image file, a spreadsheet file, and a portable document format (PDF) file. The order level information can comprise at least a customer name, a delivery date, and a customer purchase order number and the item level information can comprise one or more generic product names. The operations also comprise preprocessing the order level information and the item level information into a plurality of machine learning features and inputting the machine learning features into a machine learning model to obtain predictions concerning a product code from a product database corresponding to one of the generic product names, the delivery date, the customer purchase order number, and a customer record corresponding to the customer name. The operations further comprise generating a sales order based in part on the product code, the delivery date, the customer purchase order number, and the customer record predicted by the machine learning model and instructing a supplier client device to display the sales order to a supplier.

### BRIEF DESCRIPTION OF THE DRAWINGS

FIG. 1 illustrates one embodiment of a system for the automated ingestion and processing of orders.

FIG. 2 is a workflow diagram illustrating a method for ingesting and processing inbound purchase orders in various forms or file formats.

FIG. 3 illustrates one embodiment of an order graphical user interface (GUI) that can be displayed to a supplier on a supplier client device to initiate the process of generating a sales order in response to the supplier dragging and dropping a purchase order (e.g., a voicemail audio file, a PDF file, etc.) onto the order GUI.

FIG. 4 illustrates one embodiment of a dashboard GUI showing a sales order generated from a text message serving as the purchase order.

FIG. 5 illustrates another embodiment of the dashboard GUI showing a sales order generated from a voicemail audio file serving as the purchase order.

FIG. 6A illustrates one embodiment of a purchase order in the form of a PDF file.

FIG. 6B illustrates yet another embodiment of the dashboard GUI showing a sales order generated from the PDF file serving as the purchase order.

FIG. 7 illustrates that the supplier can edit or correct the sales order by applying user inputs to the dashboard GUI displaying the sales order.

### DETAILED DESCRIPTION

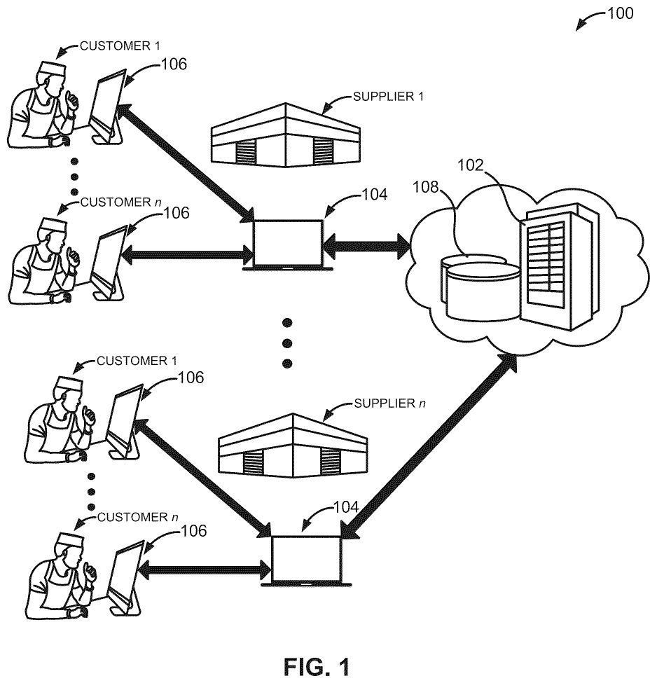

FIG. 1 illustrates one embodiment of a system 100 for the automated ingestion and processing of orders. The system 100 can comprise one or more servers 102 and a plurality of supplier client devices 104 communicatively coupled to the one or more servers 102. Each of the one or more servers 102 can comprise one or more processors and one or more memory units communicatively coupled to the one or more processors.

The one or more servers 102 can comprise or refer to one or more virtual servers or virtualized computing resources. For example, the one or more servers 102 can refer to virtual servers or cloud servers hosted and delivered by a cloud computing platform (e.g., Amazon Web Services®, Microsoft Azure®, or Google Cloud®). In other embodiments, the one or more servers 102 can refer to one or more stand-alone servers such as rack-mounted servers, blade servers, mainframes, dedicated desktop or laptop computers, one or more processors or processor cores therein, or a combination thereof.

The supplier client devices 104 can refer to client devices used by suppliers or distributors such as wholesale grocery suppliers or distributors. The supplier client devices 104 can comprise or refer to one or more personal communication devices, such as laptop computers, desktop computers, smartphones, tablet computers, other types of personal computing devices, smartwatches, or smart glasses.

FIG. 1 also illustrates that the system 100 can optionally comprise a plurality of customer client devices 106 used by the customers of the suppliers or distributors to generate and transmit orders to the supplier client devices 104. For example, the customers can use the customer client devices 106 to send or otherwise convey orders (e.g., purchase orders) in various file formats to the supplier client devices 104.

In some embodiments, the one or more servers 102 can be communicatively coupled to hundreds, thousands, or even millions of supplier client devices 104. In these embodiments, each of the supplier client devices 104 can receive orders from hundreds, thousands, or even millions of customer client devices 106. Since each order can comprise up to several hundred line items, along with customized instructions and quantity information related to each of the line items, the system 100 saves each of the supplier client devices 104 a significant amount of time that would otherwise have to be spent on manually creating each of the orders.

The supplier client devices 104 can communicate with the one or more servers 102 over one or more networks. In some embodiments, the one or more networks can refer to one or more wide area networks (WANs) such as the Internet or other smaller WANs, wireless local area networks (WLANs), local area networks (LANs), wireless personal area networks (WPANs), system-area networks (SANs), metropolitan area networks (MANs), campus area networks (CANs), enterprise private networks (EPNs), virtual private networks (VPNs), multi-hop networks, or a combination thereof. The one or more servers 102 and the supplier client devices 104 can connect to the one or more networks using any number of wired connections (e.g., Ethernet, fiber optic cables, etc.), wireless connections established using a wireless communication protocol or standard such as a 3G wireless communication standard, a 4G wireless communication standard, a 5G wireless communication standard, a long-term evolution (LTE) wireless communication standard, a Bluetooth™ (IEEE 802.15.1) or Bluetooth™ Lower Energy (BLE) short-range communication protocol, a wireless fidelity (WiFi) (IEEE 802.11) communication protocol, an ultra-wideband (UWB) (IEEE 802.15.3) communication protocol, a ZigBee™ (IEEE 802.15.4) communication protocol, or a combination thereof.

The supplier client devices 104 can transmit data and files to the one or more servers 102 and receive data and files from the one or more servers 102 via secure connections. The secure connections can be real-time bidirectional connections secured using one or more encryption protocols such as a secure sockets layer (SSL) protocol, a transport layer security (TLS) protocol, or a combination thereof. Additionally, data or packets transmitted over the secure connection can be encrypted using a Secure Hash Algorithm (SHA) or another suitable encryption algorithm. Data or packets transmitted over the secure connection can also be encrypted using an Advanced Encryption Standard (AES) cipher.

As shown in FIG. 1, the one or more servers 102 can store data and files received from the supplier client devices 104 in one or more databases 108. In some embodiments, the one or more databases 108 can be relational databases. In other embodiments, the one or more databases 108 can be column-oriented or key-value databases. In some embodiments, the one or more databases 108 can be stored in the memory or storage units of the one or more servers 102. In other embodiments, the one or more databases 108 can be distributed among multiple storage nodes.

In some embodiments, the one or more servers 102 can comprise one or more server processors, server memory and storage units, and a server communication interface. The server processors can be coupled to the server memory and storage units and the server communication interface through high-speed buses or interfaces.

The one or more server processors can comprise one or more CPUs, GPUs, ASICs, FPGAs, or a combination thereof. The one or more server processors can execute software stored in the server memory and storage units to execute the methods or instructions described herein. The one or more server processors can be embedded processors, processor cores, microprocessors, logic circuits, hardware FSMs, DSPs, or a combination thereof. The one or more server processors can be configured to run one or more deep learning models or neural networks (e.g., convolutional neural networks).

The server memory and storage units can store software, data (including audio, video, or image data), tables, logs, databases, or a combination thereof. The server memory and storage units can comprise an internal memory and/or an external memory, such as a memory residing on a storage node or a storage server. The server memory and storage units can be a volatile memory or a non-volatile memory. For example, the server memory and storage units can comprise nonvolatile storage such as NVRAM, Flash memory, solid-state drives, hard disk drives, and volatile storage such as SRAM, DRAM, or SDRAM.

The server communication interface can refer to one or more wired and/or wireless communication interfaces or modules. For example, the server communication interface can be a network interface card. The server communication interface can comprise or refer to at least one of a WiFi communication module, a cellular communication module (e.g., a 4G or 5G cellular communication module), and a Bluetooth®/BLE or other type of short-range communication module.

The one or more servers 102 can connect to or communicatively couple with each of the supplier client devices 104 via the server communication interface. The one or more servers 102 can transmit or receive packets of data using the server communication interface.

Software instructions run on the one or more servers 102, including any of the method steps or workflows disclosed herein, can be written in the Ruby® programming language, Python® programming language, Java® programming language, C programming language, C++ programming language, C # programming language, JavaScript programming language, or a combination thereof.

The supplier client devices 104 can comprise one or more processors, memory and storage units, and wireless communication modules. The components of the supplier client devices 104 can be connected to one another via high-speed buses or interfaces.

The processors can include one or more central processing units (CPUs), graphical processing units (GPUs), Application-Specific Integrated Circuits (ASICs), field-programmable gate arrays (FPGAs), or a combination thereof. The processors can execute software stored in the memory and storage units to execute the methods or instructions described herein.

The memory and storage units can comprise volatile memory and non-volatile memory or storage. For example, the memory and storage units can comprise flash memory or storage such as one or more solid-state drives, dynamic random access memory (DRAM) or synchronous dynamic random access memory (SDRAM) such as low-power double data rate (LPDDR) SDRAM and embedded multi-media controller (eMMC) storage. The memory and storage units can store software, firmware, data, tables, logs, databases, or a combination thereof.

The wireless communication modules can comprise at least one of a cellular communication module, a WiFi communication module, a Bluetooth® communication module, or a combination thereof. For example, the cellular communication module can support communications over a 5G network or a 4G network (e.g., a 4G long-term evolution (LTE) network) with automatic fallback to 3G networks. The cellular communication module can comprise a number of embedded SIM cards or embedded universal integrated circuit cards.

The WiFi communication module can allow the supplier client devices 104 to communicate over one or more WiFi (IEEE 802.11) commination protocols such as the 802.11n, 802.11ac, or 802.11ax protocol. The Bluetooth® module can allow the supplier client devices 104 to communicate with other client device over a Bluetooth® communication protocol (e.g., Bluetooth® basic rate/enhanced data rate (BR/EDR), a Bluetooth® low energy (BLE) communication protocol, or a combination thereof).

The display of each of the supplier client devices 104 can be a touchscreen display such as a liquid crystal display (LCD), an organic light-emitting diode (OLED) display, an active-matrix organic light-emitting diode (AMOLED) display, a super-AMOLED (S-AMOLED) display, a super LCD display (S-LCD), a thin film transistor (TFT) display, or a flexible instance of the aforementioned displays. In certain embodiments, the display can be a retina display, a haptic touchscreen, or a combination thereof. For example, when one of the supplier client devices 104 is a smartphone, the display can be the touchscreen display of the smartphone.

Software instructions run on the supplier client devices 104 can be written in the Objective-C programming language, Swift® programming language, Java® programming language, JavaScript programming language, Python® programming language, Kotlin® programming language, Golang™ programming language, C++ programming language, or a combination thereof.

In some embodiments, the system 100 can be provided as a cloud-based solution. For example, the front end of the system 100 (e.g., the user interfaces disclosed herein) can be implemented as one or more web applications using a framework hosted on an Elastic Cloud Compute (EC2) instance on Amazon Web Services (AWS). In these embodiments, the backend system can partition a separate compute service for each independent order stream or submission, allowing for a large number of concurrent orders or submissions.

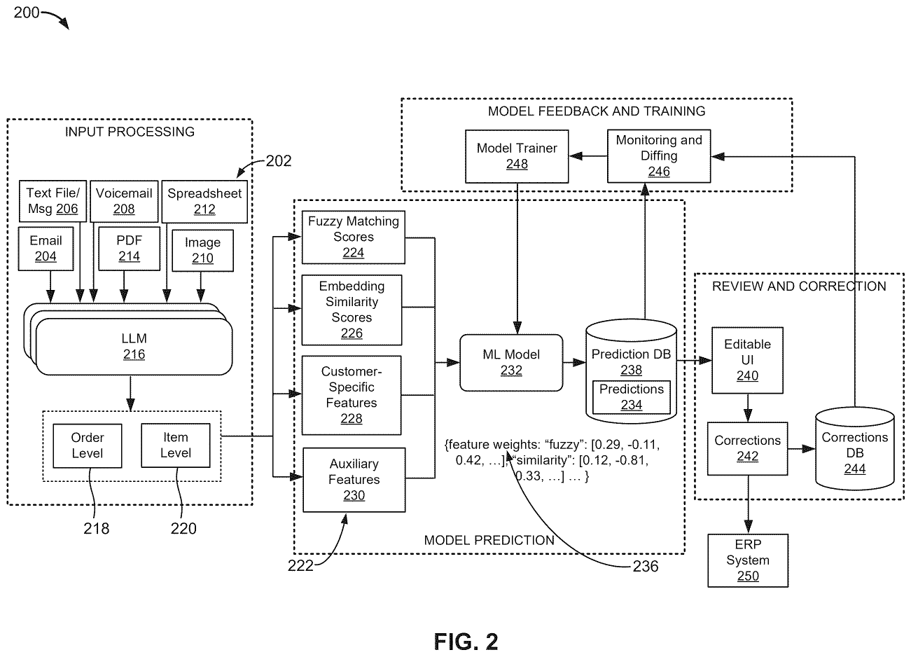

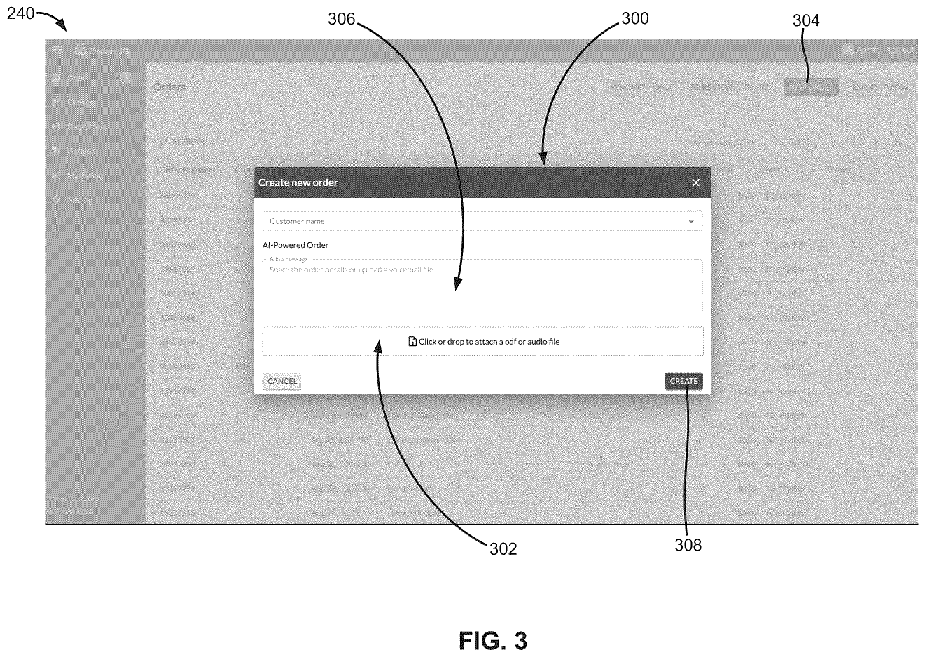

FIG. 2 is a workflow diagram illustrating a computer-implemented method 200 for ingesting and processing purchase orders 202. The method 200 can be initiated when one of the suppliers uploads at least one of an email message 204, a text file or text message 206, a voicemail audio file 208, an image file 210 (e.g., a digital photo of an order), a spreadsheet file 212, and/or a portable document format (PDF) file 214 serving as the purchase order 202 to the server 102 using the supplier client device 104. For example, the supplier can drag and drop a voicemail audio file 208, a PDF file 214, an image file 210, and/or a spreadsheet file 212 onto an order graphical user interface 300 (GUI) (see, e.g., FIG. 3) displayed as part of a web-based user dashboard.

In other embodiments, the supplier can copy and paste text from an email message 204 or a text message 206 into a text entry box of the order GUI 300 (see also FIG. 3).

In further embodiments, the supplier can forward an email message 204 to an email forwarding address that transmits the email message 204 to the server 102 to be uploaded as the purchase order 202.

The supplier can receive the purchase order 202 from a customer client device 106. For example, the purchase order 202 can be received via different communication channels or protocols including via an email communication protocol, a text message communication protocol, or a voice over internet protocol (e.g., user datagram protocol (UDP). In some embodiments, the purchase order 202 can initially be stored on the supplier client device 104 before being uploaded or otherwise transmitted to the one or more servers 102.

In some embodiments, the purchase order 202 can be divided into multiple partial orders comprising at least a first partial order and a second partial order. For example, the first partial order can be in the form of an email message 204, a text file or text message 206, a voicemail audio file 208, an image file 210, a spreadsheet file 212, or a PDF file 214 and the second partial order can be in a different form or file format from the first partial order. As a more specific example, the first partial order can be in the form of a text message 206 and the second partial order can be in the form of a voicemail audio file 208.

One technical advantage of the system 100 and method 200 disclosed herein is that it allows suppliers to ingest a purchase order 202 when the purchase order 202 is spread between multiple partial orders. The system 100 and method 200 disclosed herein can also allow suppliers to ingest a purchase order 202 spread between multiple partial orders even when the multiple partial orders are in different forms or file formats such as voicemail audio files, text files or text messages, PDFs, emails, and/or images. This scenario is all too common in the food supply chain industry where a supplier will transmit, for example, part of an order as a text message and then add to the order via voicemail or email.

The method 200 can also comprise extracting, using one or more large language models (LLMs) 216, order level information 218 and item level information 220 from the purchase order 202. In certain embodiments, the one or more LLMs 216 can comprise at least one of GPT-4o, GPT-5, and Gemini.

In some embodiments, at least one LLM 216 can extract at least a customer name, a delivery date, and a customer purchase order number from the purchase order 202 as part of the order level information 218.

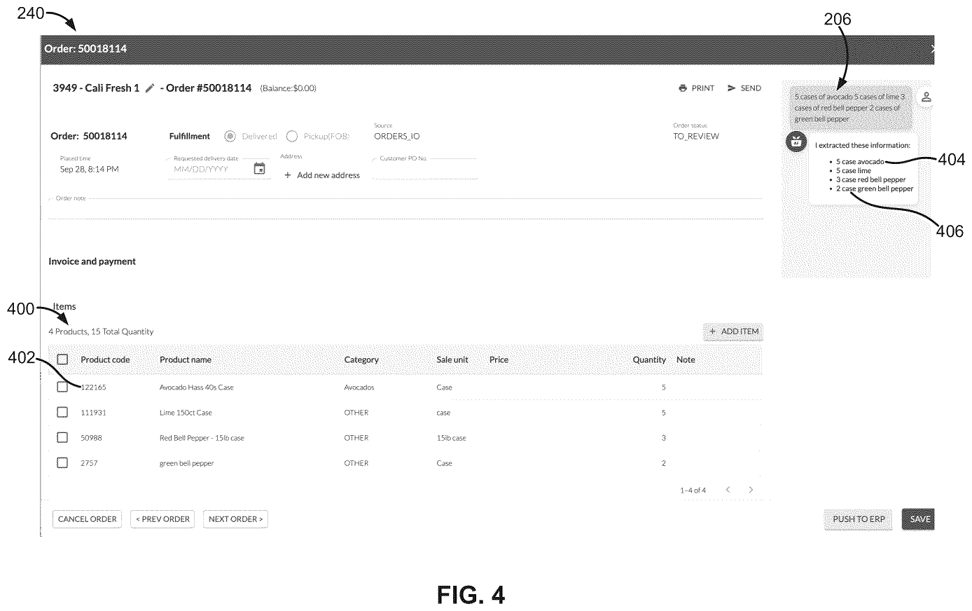

At least one LLM 216 can also extract one or more generic product names 404 (see, e.g., FIGS. 4, 5, 6B, and 7) from the purchase order 202 as part of the item level information 220. For example, the generic product names 404 can be generic or common names for products such as “milk,” “chicken breast,” “potatoes,” “spinach,” “broccoli,” “apples,” etc. The LLM 216 can further extract, as part of the item level information 220, units of measure (e.g., pounds, liters, cases, boxes, etc.), quantities (e.g., 3 pounds, 1 liter, 5 cases, 2 boxes, etc.), and/or pricing information (e.g., $5 per pound, $2 per liter, $20 per case, $10 per box, etc.) from the purchase order 202.

In some embodiments, the purchase order 202 can be in the form of a voicemail audio file 208. In these embodiments, the method 200 can further comprise using a first LLM (one of the LLMs 216) optimized for voice transcription or speech-to-text conversion to transcribe the voicemail audio file 208 into transcribed text and then extracting, using a second LLM (another one of the LLMs 216), the order level information 218 and the item level information 220 from the transcribed text. For example, the first LLM can encode image data or audio data into a format (e.g., text string) that the transformer architecture of the second LLM can understand.

In certain embodiments, the first LLM used for voice transcription (e.g., GPT-4o-transcribe) can be different from the second LLM (e.g., GPT-4o, GPT-5, or Gemini) used to extract the order level information 218 and the item level information 220 from the transcribed text.

The first LLM can also translate the transcribed text of a voicemail audio file 208 in a first language into a second language. For example, the first language can be Spanish and the second language can be English. As a more specific example, the purchase order 202 can be a voicemail audio file 208 that refers to “cinco cajas de manzanas . . . ” The first LLM can translate the transcribed text to “five cases of apples” and provide the translated generic product name 404 of “apples” and the translated unit of measure of “cases” as inputs for the second LLM.

With the order level information 218 and the item level information 220 extracted from the purchase order 202, the next step of the method 200 can also comprise using machine learning to match the order level information 218 and the item level information 220 extracted to known information (e.g., specific product codes and/or customer records) from one or more databases 108 accessible to the server 102 (see, e.g., FIG. 1).

In some embodiments, the method 200 can comprise preprocessing the order level information 218 and the item level information 220 extracted into a plurality of machine learning features 222.

In some embodiments, the method 200 can comprise preprocessing the order level information 218 and/or the item level information 220 into one or more fuzzy text match scores 224, one or more semantic embedding similarity scores 226, one or more customer-specific features 228, and one or more auxiliary features 230 serving as the machine learning features 222. As a more specific example, the method 200 can comprise preprocessing the generic product names 404 into one or more fuzzy text match scores 224 (calculated based on text string matches), one or more semantic embedding similarity scores 226 (calculated based on cosine similarities between embeddings), or a combination thereof.

In certain embodiments, text from the item level information 220 can be normalized by converting it to lowercase and removing any unnecessary symbols, spaces, line breaks, etc. An LLM can then be used to perform semantic recognition (including multilingual understanding and alias detection) on the normalized text. The most relevant matching results can then be computed after the semantic recognition step.

The method 200 can also comprise inputting the machine learning features 222 into a machine learning model 232 to obtain certain predictions 234 from the machine learning model 232. The machine learning features 222 can be combined with model weights 236 to obtain predictions 234 concerning one or more product codes 402 and a customer record. The machine learning model 232 can be specifically trained to match generic product names 404 extracted from the purchase orders 202 to product codes 402 (see, e.g., FIGS. 4, 5, 6B, and 7) from a product database. The machine learning model 232 can also be trained to match customer names extracted from purchase orders 202 to customer records. The product database and/or the customer database can refer to one or more databases 108 (see, e.g., FIG. 1) communicatively coupled to or otherwise accessible to the server 102.

In some embodiments, the machine learning model 232 can be another instance of the LLM 216 or an additional LLM. In all such embodiments, the machine learning model 232 can have a transformer architecture.

The method 200 can further comprise inputting a plurality of additional machine learning features 222 including customer-specific features 228, auxiliary features 230, or a combination thereof into the machine learning model 232 to further bolster or improve the predictions 234 concerning the product codes and/or customer records. The plurality of customer-specific features 228 and the auxiliary features 230 are not explicitly included as part of the purchase order 202.

For example, the plurality of customer-specific features 228 can comprise an order history associated with a customer, an order frequency associated with the customer, and an order guide or product list made available to the customer. The auxiliary features 230 can comprise data or information concerning a day that the purchase order 202 was received, a month that the purchase order 202 was received, a current season during which the purchase order 202 was received, and/or a current weather condition during which the purchase order 202 was received.

For example, the generic product names 404 “potatoes” and “lemons” can be extracted from a purchase order 202 uploaded by a supplier. Moreover, additional item level information 220 such as “3 bags” and “2 boxes” can be extracted from the purchase order 202. In addition, a customer name of “Mi Familia” can also be extracted from the same purchase order 202. The server 102 can preprocess the extracted order level information 218 and item level information 220, including generic product names 404, into fuzzy text match scores 224 and/or semantic embedding similarity scores 226 based on their similarity to official names of products from a product database and customer records from the customer database. In this example, the machine learning model 232 can output a prediction 234 that the generic product name “potatoes” is actually “Yukon Gold potatoes in 50 pound bags with a product code of #86518 and the generic product name of “lemons” is actually “Meyer lemons in 18 pound boxes with a product code of #190387. Moreover, the machine learning model 232 can also output a prediction 234 that the customer is actually “Mi Familia Market.”

As shown in FIG. 2, the predictions 234 outputted by the machine learning model 232 can be stored in a prediction database 238.

The method 200 can further comprise automatically generating a sales order 400 (see, e.g., FIG. 4, 5, 6B, or 7) from the purchase order 202 based in part on the product code, the delivery date, the customer purchase order number, and the customer record predicted by the machine learning model 232. The supplier client device 104 can be instructed to display the sales order 400 to the supplier once the sales order 400 has been generated. For example, the sales order 400 can be displayed as part of a dashboard GUI 240 (see, e.g., FIG. 4, 5, 6B, or 7) presented on a display or screen of the supplier client device 104.

As will be discussed in more detail in the following sections, the dashboard GUI 240 can be edited by the supplier to correct any mistakes outputted by the machine learning model 232. The system 100 can receive one or more corrections 242 to the sales order from the supplier via user inputs applied directly to the dashboard GUI 240 resulting in a corrected sales order. The corrected sales order can be stored as part of a corrections database 244.

Any corrections 242 made to the sales order 400 by the supplier can be considered ground truth data or golden data/results. A monitoring and diffing module 246 can then compare the one or more corrections 242 made by the supplier to the predictions 234 outputted by the machine learning model 232. As shown in FIG. 2, in some instances, the monitoring and diffing module 246 can retrieve the corrections 242 from the corrections database 244.

A model trainer 248 or model training module can then further train the machine learning model 232 based on the differences between the corrections 242 made by the supplier and the predictions 234 outputted by the machine learning model 232. For example, the model trainer 248 can instruct the machine learning model 232 to once again generate predictions 234 using the original purchase order 202 and compare the differences between the predictions 234 and the ground truth data. The model trainer 248 can use any differences to re-train or further train the model by adjusting or fine-tuning a plurality of weights 236 of the machine learning model 232. The model trainer 248 can re-train or further train the model by continuing to adjust or fine-tune the weights 236 of the machine learning model 232 until the new predictions outputted by the machine learning model 232 match or more closely align with the corrections 242 made by the supplier.

In this manner, the machine learning model 232 can be configured to self-learn or self-improve over time based on human-in-the-loop (HITL) feedback provided by the supplier.

The method 200 can further comprise automatically adding the sales order 400 (or a corrected instance of the sales order 400) to a database of an enterprise resource planning (EPR) system 250 of the supplier or automatically converting the sales order 400 into a format that can be read by the ERP system 250 of the supplier. In some embodiments, the server 102 can export the sales order 400 directly to the ERP system 250 of the supplier via one or more application programming interfaces (APIs) or via other transfer approaches (e.g., CSV to FTP). In these embodiments, the data fields in the sales order 400 can be mapped directly to data fields of the ERP system 250.

In other embodiments, the method 200 can also comprise exporting the sales order 400 as a spreadsheet file, a comma-separated values (CSV) file, a PDF file, and/or a JSON file.

FIG. 3 illustrates one embodiment of an order graphical user interface (GUI) 300 that can be displayed to a supplier on a supplier client device 104 to initiate the process of generating a sales order 400 in response to the supplier dragging and dropping a purchase order 202 (e.g., a voicemail audio file 208, a PDF file 214, etc.) onto the order GUI 300.

For example, as shown in FIG. 3, a purchase order 202 in the form of a voicemail audio file 208 or a PDF file 214 can be dragged and dropped onto a drag-and-drop bar 302 of the order GUI 300. In addition, any of an email message 204, a text file 206, an image file 210, or a spreadsheet file 212 can also be dragged and dropped onto a drag-and-drop bar 302 of the order GUI 300.

In these embodiments, dragging and dropping the purchase order 202 onto the drag-and-drop bar 302 of the order GUI 300 can trigger the system 100 to begin extracting the order level information 218 and the item level information 220 from the purchase order 202 using the LLM 216.

In embodiments where the purchase order 202 is in the form of a voicemail audio file 208, dragging and dropping the voicemail audio file 208 onto the drag-and-drop bar 302 of the order GUI 300 can trigger the system 100 to convert the voicemail audio file 208 into an unstructured text file by providing the voicemail audio file 208 as an input to an instance of the LLM 216 trained for speech-to-text transcription.

Also, in embodiments where the purchase order 202 is in the form of a PDF file 214, dragging and dropping the PDF file 214 onto the drag-and-drop bar 302 of the order GUI 300 can trigger the system 100 to run an optical-character-recognition (OCR) workflow or algorithm to recognize the alphanumeric characters in the PDF file 214 and to provide the alphanumeric characters as inputs to the LLM 216 to extract the order level information 218 and the item level information 220 from the PDF file 214.

In some embodiments, the order GUI 300 can be displayed on the supplier client device 104 when the supplier applies a user input (e.g., a click input or a touch input) to a new order button 304 on the dashboard GUI 240.

As shown in FIG. 3, the order GUI 300 can also comprise a text entry box 306. A supplier can also initiate the process of generating the sales order 400 by copying-and-pasting unstructured text from a text message 206 or an email message into the text entry box 306. Moreover, the supplier can also type an order into the text entry box 306. In these embodiments, the supplier can trigger the system 100 to begin extracting the order level information 218 and the item level information 220 from the text pasted into the text entry box 306 by applying a user input (e.g., a click input or a touch input) to a create order button 308 on the order GUI 300.

FIG. 4 illustrates one embodiment of the dashboard GUI 240 showing a sales order 400 automatically generated from a purchase order 202 in the form of unstructured text copied-and-pasted from a text message 206. As previously discussed, the sales order 400 can be automatically generated based in part on the product codes 402 predicted by the machine learning model 232. The product codes 402 can be obtained as outputs from the machine learning model 232 using generic product names 404 extracted from the text message 206 using the LLM 216 (see, e.g., FIG. 2).

The LLM 216 can also extract other item level information 220 such as quantity information 406 from the purchase order 202 (e.g., the text message 206). Moreover, the LLM 216 can also extract order level information 218 from the purchase order 202. All such information can be included as part of the sales order 400.

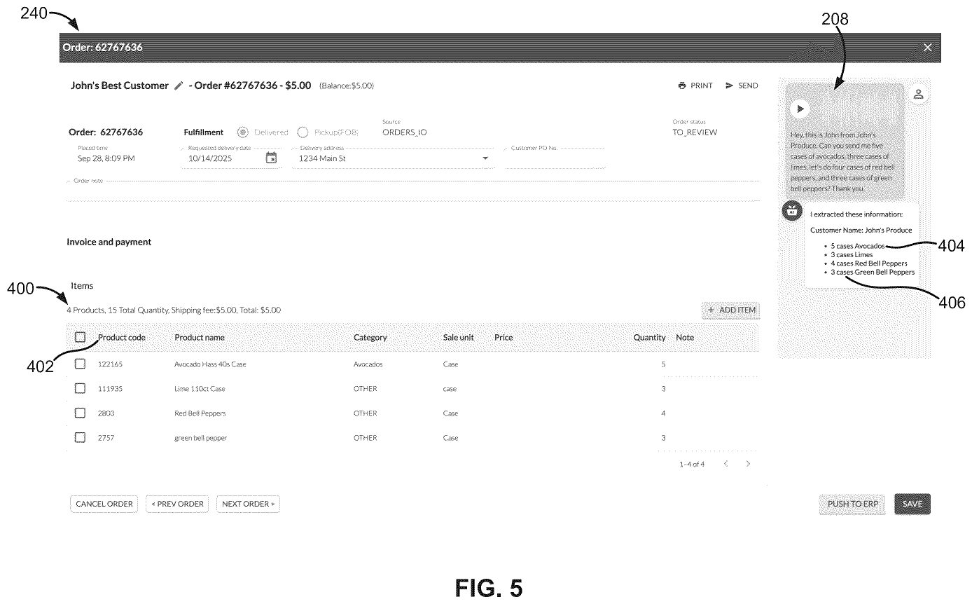

FIG. 5 illustrates another embodiment of the dashboard GUI 240 showing a sales order 400 automatically generated from a voicemail audio file 208. The voicemail audio file 208 can be dragged and dropped onto the drag-and-drop bar 302 of the order GUI 300 (see, e.g., FIG. 3). An LLM 216 trained for speech-to-text transcription can then transcribe the voicemail audio file 208 into unstructured text that can then be provided to another instance of the LLM 216 to extract the order level information 218 and the item level information 220 (e.g., generic product names 404 and quantity information 406) from the transcribed text.

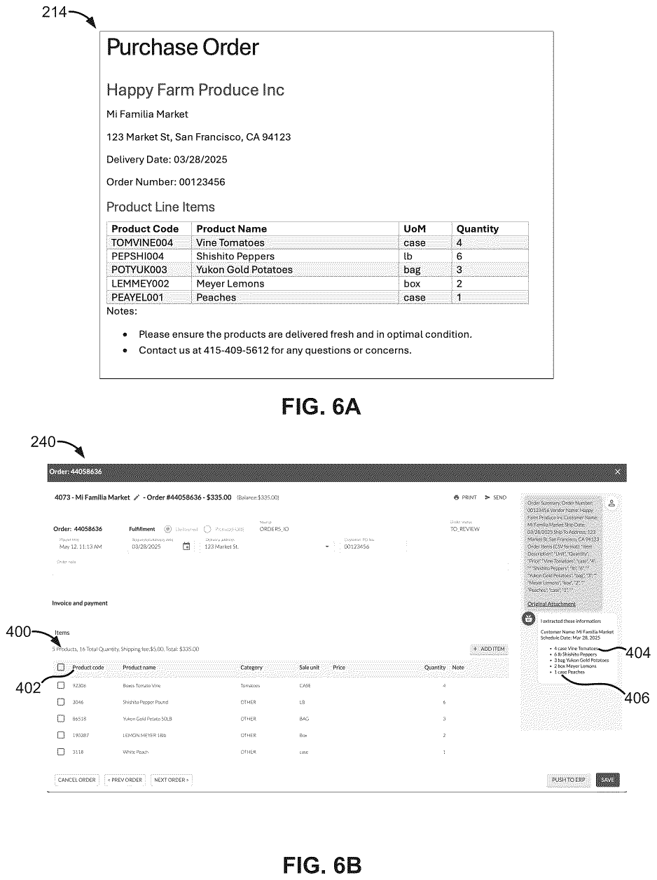

FIG. 6A illustrates one embodiment of a purchase order 202 in the form of a PDF file 214. In some embodiments, the PDF file 214 can be subjected to an optical-character-recognition (OCR) workflow or algorithm to recognize the alphanumeric characters in the PDF file 214 before extracting the order level information 218 and the item level information 220 from the PDF file 214. In other embodiments, the PDF file 214 can be provided as an input to the LLM 216 to convert the PDF file 214 to a CSV file or plain text file before extracting the order level information 218 and the item level information 220.

FIG. 6B illustrates yet another embodiment of the dashboard GUI 240 showing a sales order 400 generated from the PDF file 214 (see FIG. 6A). The PDF file 214 can be dragged and dropped onto the drag-and-drop bar 302 of the order GUI 300 (see, e.g., FIG. 3) to initiate the process of extracting the order level information 218 and the item level information 220 from the PDF file 214.

As shown in FIGS. 6A and 6B, the PDF file 214 can contain different product codes than the product codes 402 used by the supplier. In this case, the LLM 216 can extract the generic product names 404 and the quantity information 406 without extracting the product codes from the PDF file 214. For example, the LLM 216 can compare the product codes from the PDF file 214 against the product codes from the product database and ignore or discard any product codes from the PDF file 214 that do not match the product codes from the product database.

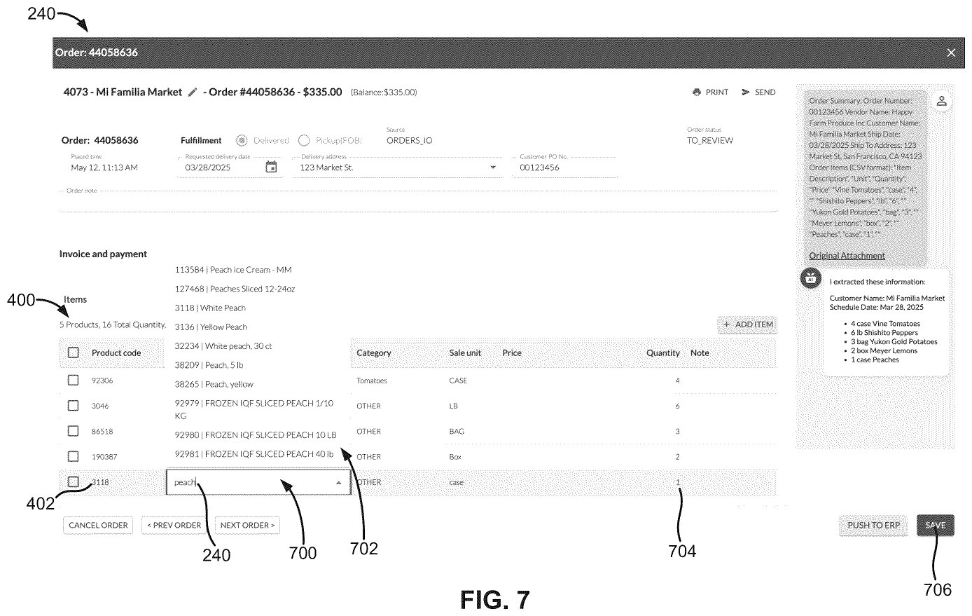

FIG. 7 illustrates that the supplier can edit or correct the sales order 400 by applying user inputs directly to the sales order 400 displayed as part of the dashboard GUI 240. For example, the supplier can edit or correct the sales order 400 by typing corrections 242 directly into a product name field 700 of the sales order 400 displayed as part of the editable dashboard GUI 240. In alternative embodiments, the supplier can edit or correct the sales order 400 by applying a user input (e.g., a click input or a touch input) to the product name field 700 and selecting a different product from a list of suggested products 702 automatically generated by the system 100. Once the supplier selects a different product, the product code 402 of the new product can be displayed as part of the corrected sales order (which can replace the old product code of the previously incorrect product).

As shown in FIG. 7, the supplier can also edit or correct the sales order 400 by typing directly into a quantity field 704 of the sales order 400 displayed as part of the editable dashboard GUI 240.

In some embodiments, the system 100 can receive the corrections 242 to the sales order 400 once the supplier applies a user input (e.g., a click input or a touch input) to a save button 706 displayed as part of the dashboard GUI 240. This can result in the corrected sales order being saved and stored as part of the corrections database 244 (see, e.g., FIG. 2).

As previously discussed, any corrections made to the sales order 400 by the supplier can be considered ground truth data or golden data/results. A monitoring and diffing module 246 of the system 100 can then compare the one or more corrections 242 made by the supplier to the predictions 234 outputted by the machine learning model 232. For example, the monitoring and diffing module 246 can retrieve the corrections 242 made by the supplier from the corrections database 244.

The model trainer 248 or model training module (see, e.g., FIG. 2) can then re-train or further train the machine learning model 232 based on the differences between the corrections 242 made by the supplier and the predictions 234 outputted by the machine learning model 232. For example, the model trainer 248 can instruct the machine learning model 232 to once again generate predictions 234 using the original purchase order 202 and see the differences between the predictions 234 and the ground truth data or golden data/results.

The model trainer 248 can use any differences between the predictions 234 and the ground truth data to re-train or further train the model by adjusting or fine-tuning the weights 236 of the machine learning model 232. The model trainer 248 can continue to adjust or fine-tune the weights 236 until the new predictions outputted by the machine learning model 232 match or more closely align with the corrections 242 made by the supplier. By doing so, the machine learning model 232 can iteratively and automatically improve its performance over time based on HITL feedback provided by the supplier.

A number of embodiments have been described. Nevertheless, it will be understood by one of ordinary skill in the art that various changes and modifications can be made to this disclosure without departing from the spirit and scope of the embodiments. Elements of systems, devices, apparatus, and methods shown with any embodiment are exemplary for the specific embodiment and can be used in combination or otherwise on other embodiments within this disclosure. For example, the steps of any methods depicted in the figures or described in this disclosure do not require the particular order or sequential order shown or described to achieve the desired results. In addition, other steps operations may be provided, or steps or operations may be eliminated or omitted from the described methods or processes to achieve the desired results. Moreover, any components or parts of any apparatus or systems described in this disclosure or depicted in the figures may be removed, eliminated, or omitted to achieve the desired results. In addition, certain components or parts of the systems, devices, or apparatus shown or described herein have been omitted for the sake of succinctness and clarity.

Accordingly, other embodiments are within the scope of the following claims and the specification and/or drawings may be regarded in an illustrative rather than a restrictive sense.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit, or scope of the present invention.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein. For example, a description of a range from 1 to 5 should be considered to have disclosed subranges such as from 1 to 3, from 1 to 4, from 2 to 4, from 2 to 5, from 3 to 5, etc. as well as individual numbers within that range, for example 1.5, 2.5, etc. and any whole or partial increments therebetween.

All existing subject matter mentioned herein (e.g., publications, patents, patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

Reference to the phrase “at least one of” when such phrase modifies a plurality of items or components (or an enumerated list of items or components) means any combination of one or more of those items or components. For example, the phrase “at least one of A, B, and C” means: (i) A; (ii) B; (iii) C; (iv) A, B, and C; (v) A and B; (vi) B and C; or (vii) A and C.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” “member” “element,” or “component” when used in the singular can have the dual meaning of a single part or a plurality of parts. As used herein, the following directional terms “forward, rearward, above, downward, vertical, horizontal, below, transverse, laterally, and vertically” as well as any other similar directional terms refer to those positions of a device or piece of equipment or those directions of the device or piece of equipment being translated or moved.

Finally, terms of degree such as “substantially,” “about,” and “approximately” as used herein mean the specified value or the specified value and a reasonable amount of deviation from the specified value (e.g., a deviation of up to ±0.1%, ±1%, ±5%, or ±10%, as such variations are appropriate) such that the end result is not significantly or materially changed. For example, “about 1.0 cm” can be interpreted to mean “1.0 cm” or between “0.9 cm and 1.1 cm.” When terms of degree such as “about” or “approximately” are used to refer to numbers or values that are part of a range, the term can be used to modify both the minimum and maximum numbers or values.

The term “engine” or “module” as used herein can refer to software, firmware, hardware, or a combination thereof. In the case of a software implementation, for instance, these may represent program code that performs specified tasks when executed on a processor (e.g., CPU, GPU, or processor cores therein). The program code can be stored in one or more computer-readable memory or storage devices. Any references to a function, task, or operation performed by an “engine” or “module” can also refer to one or more processors of a device or server programmed to execute such program code to perform the function, task, or operation.

It will be understood by one of ordinary skill in the art that the various methods disclosed herein may be embodied in a non-transitory readable medium, machine-readable medium, and/or a machine accessible medium comprising instructions compatible, readable, and/or executable by a processor or server processor of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

We claim:

1. A method of processing an order, comprising:
extracting, using a large language model (LLM), order level information and item level information from a purchase order, wherein the purchase order is in the form of at least one of an email message, a text message, a voicemail audio file, an image file, a
spreadsheet file, and a portable document format (PDF) file;
preprocessing the order level information and the item level information into a plurality of machine learning features, wherein the order level information comprises at least a customer name, a delivery date, and a customer purchase order number, and wherein the item level information comprises one or more generic product names;
inputting the machine learning features into a machine learning model to obtain predictions concerning a product code from a product database corresponding to one of the generic product names, the delivery date, the customer purchase order number, and a customer record corresponding to the customer name; and
generating a sales order based in part on the product code, the delivery date, the customer purchase order number, and the customer record predicted by the machine learning model and displaying the sales order to a supplier via a supplier client device.

2. The method of claim 1, further comprising:
displaying, via the supplier client device, the sales order to the supplier via an editable dashboard graphical user interface (GUI);
receiving one or more corrections to the sales order from the supplier via user inputs applied to the dashboard GUI resulting in a corrected sales order;
comparing the one or more corrections to the predictions outputted by the machine learning model; and
adjusting or fine-tuning a plurality of weights of the machine learning model until new predictions outputted by the machine learning model match the corrected sales order.

3. The method of claim 1, wherein preprocessing the item level information further comprises preprocessing the one or more generic product names into the plurality of machine learning features, wherein the machine learning features comprises a fuzzy text match score and a semantic embedding similarity score.

4. The method of claim 3, further comprising inputting a plurality of auxiliary features into the machine learning model to obtain the predictions concerning the product code, wherein the auxiliary features are not explicitly included as part of the purchase order, wherein the auxiliary features comprise data or information concerning a day that the purchase order was received, a month that the purchase order was received, a current season during which the purchase order was received, and a current weather condition during which the purchase order was received.

5. The method of claim 4, further comprising inputting a plurality of customer-specific features into the machine learning model to obtain the predictions concerning the product code, wherein the plurality of customer-specific features are not explicitly included as part of the purchase order, wherein the plurality of customer-specific features comprise an order history associated with a customer, an order frequency associated with the customer, and an order guide or product list made available to the customer.

6. The method of claim 1, wherein the machine learning model is another instance of the LLM or an additional LLM.

7. The method of claim 1, wherein the purchase order is divided into a first partial order and a second partial order, wherein the first partial order is in the form of the email message, the text message, the voicemail audio file, the image file, the spreadsheet file, or the PDF file and wherein the second partial order is in a different form from the first partial order.

8. The method of claim 1, wherein the purchase order is in the form of the voicemail audio file, wherein the method further comprises transcribing the voicemail audio file into transcribed text using an additional LLM and extracting the order level information and the item level information from the transcribed text.

9. The method of claim 1, wherein extracting the order level information using the LLM further comprises extracting a shipping address from the purchase order.

10. The method of claim 1, wherein extracting the item level information using the LLM further comprises extracting units of measure, quantities, and prices from the purchase order.

11. The method of claim 1, further comprising displaying an order graphical user interface (order GUI) on the supplier client device and extracting the order level information and item level information from the purchase order in response to the supplier dragging and dropping the voicemail audio file or the PDF file onto the order GUI.

12. The method of claim 1, further comprising automatically adding the sales order to an enterprise resource planning (EPR) database.

13. A system for processing orders, the system comprising:
a server comprising one or more processors and one or more memory units communicatively coupled to the one or more processors, wherein the one or more memory units store instructions that, when executed by the one or more processors, cause the one or more processors to:
extract, using a large language model (LLM), order level information and item level information from a purchase order, wherein the purchase order is in the form of at least one of an email message, a text message, a voicemail audio file, an image file, a spreadsheet file, and a portable document format (PDF) file,
preprocess the order level information and the item level information into a plurality of machine learning features, wherein the order level information comprises at least a customer name, a delivery date, and a customer purchase order number, and wherein the item level information comprises one or more generic product names,
input the machine learning features into a machine learning model to obtain predictions concerning a product code from a product database corresponding to one of the generic product names, the delivery date, the customer purchase order number, and a customer record corresponding to the customer name, and
generate a sales order based in part on the product code, the delivery date, the customer purchase order number, and the customer record predicted by the machine learning model; and
a supplier client device communicatively coupled to the server, wherein the supplier client device is configured to display the sales order generated by the server to a supplier.

14. The system of claim 13, wherein the one or more memory units store instructions that, when executed by the one or more processors, further cause the one or more processors to:
instruct the supplier client device to display the sales order to the supplier via an editable dashboard graphical user interface (GUI);
receive one or more corrections to the sales order from the supplier via user inputs applied to the dashboard GUI resulting in a corrected sales order;
compare the one or more corrections to the predictions outputted by the machine learning model; and
adjust or fine-tune a plurality of weights of the machine learning model until new predictions outputted by the machine learning model match the corrected sales order.

15. The system of claim 13, wherein the one or more memory units store instructions that, when executed by the one or more processors, further cause the one or more processors to preprocess the item level information by further preprocessing the one or more generic product names into the plurality of machine learning features, wherein the machine learning features comprises a fuzzy text match score and a semantic embedding similarity score.

16. The system of claim 15, wherein the one or more memory units store instructions that, when executed by the one or more processors, further cause the one or more processors to input a plurality of auxiliary features into the machine learning model to obtain the predictions concerning the product code, wherein the auxiliary features are not explicitly included as part of the purchase order, wherein the auxiliary features comprise data or information concerning a day that the purchase order was received, a month that the purchase order was received, a current season during which the purchase order was received, and a current weather condition during which the purchase order was received.

17. The system of claim 16, wherein the one or more memory units store instructions that, when executed by the one or more processors, further cause the one or more processors to input a plurality of customer-specific features into the machine learning model to obtain the predictions concerning the product code, wherein the plurality of customer-specific features are not explicitly included as part of the purchase order, wherein the plurality of customer-specific features comprise an order history associated with a customer, an order frequency associated with the customer, and an order guide or product list made available to the customer.

18. The system of claim 13, wherein the machine learning model is another instance of the LLM or an additional LLM.

19. The system of claim 13, wherein the purchase order is divided into a first partial order and a second partial order, wherein the first partial order is in the form of the email message, the text message, the voicemail audio file, the image file, the spreadsheet file, or the PDF file and wherein the second partial order is in a different form from the first partial order.

20. One or more non-transitory computer-readable media comprising instructions stored thereon, that when executed by one or more processors, cause the one or more processors to perform operations comprising:
extracting, using a large language model (LLM), order level information and item level information from a purchase order, wherein the purchase order is in the form of at least one of an email message, a text message, a voicemail audio file, an image file, a spreadsheet file, and a portable document format (PDF) file;
preprocessing the order level information and the item level information into a plurality of machine learning features, wherein the order level information comprises at least a customer name, a delivery date, and a customer purchase order number, and wherein the item level information comprises one or more generic product names;
inputting the machine learning features into a machine learning model to obtain predictions concerning a product code from a product database corresponding to one of the generic product names, the delivery date, the customer purchase order number, and a customer record corresponding to the customer name; and
generating a sales order based in part on the product code, the delivery date, the customer purchase order number, and the customer record predicted by the machine learning model and displaying the sales order to a supplier via a supplier client device.
